(19) United States
(12) Patent Application Publication
(10) Pub. No.: US 2012/0037023 A1
(43) Pub. Date: Feb. 16, 2012

(54) OFFSET PRINTING METHOD AND APPARATUS

(76) Inventors: Shuntaro Suzuki, Yokohama-shi (JP); Guilherme Jorge Maeda, Sydney, NSW (AU)

(21) Appl. No.: 13/265,653

(22) PCT Filed: Apr. 23, 2010
(86) PCT No.: PCT/JP2010/002957

§ 371 Date: Oct. 21, 2011

(30) Foreign Application Priority Data
Apr. 23, 2009 (JP) 2009-105385

(51) Int. Cl. B41F 7/02

(52) U.S. Cl. 101/217; 101/492

(57) ABSTRACT

An offset printing method of the present disclosure brings a blanket roller from above into contact with a plate held on a plate table traveling on guide rails on a mount, and then brings the blanket roller into contact with a print target held on a print target table traveling on the guide rails, to thereby perform transfer of a print pattern from the plate to the blanket roller and re-transfer of the print pattern from the blanket roller to the print target. The method further includes the steps of: causing a plate to be held on an alignment stage provided on an upper portion of the plate table and also causing a print target to be held on an alignment stage provided on an upper portion of the print target table; and correcting a position of the plate by the alignment stage of the plate table and also correcting a position of the print target by the alignment stage of the print target table.

### TECHNICAL FIELD

The present invention relates to an offset printing apparatus and an offset printing method used for performing fine printing on a print target with high print precision, such as in the case where an electrode pattern is formed on a substrate by printing.

Priority is claimed on Japanese Patent Application No. 2009-105385, filed on Apr. 23, 2009, the content of which is incorporated herein by reference.

### BACKGROUND ART

As one of the printing techniques, there is known an offset printing technique. This type of technique includes offset printing using an intaglio plate, in which ink is transferred (received) from an inked intaglio plate to a rolling blanket roller and then the ink is retransferred (printed) from the blanket roller to the print target. This method is known to be capable of printing a print pattern of the intaglio plate onto the surface of the print target with good repeatability.

In recent years, there have been proposed techniques for forming an electrode pattern (a conductive pattern) such as for liquid crystal displays on a required substrate such as a glass substrate or a substrate made from a resin. As one of them, there is a printing technique of using a conductive paste as printing ink instead of fine machining of a metal vapor-deposited film by etching or the like. As this printing technique, there have been proposed a technique of printing and forming an electrode pattern on a substrate by use of, for example, an intaglio offset printing technique (see Patent Document 1 and Patent Document 2).

When the aforementioned electrode pattern such as for liquid crystal displays is formed on a substrate, there are cases where a fine electrode width of, for example, approximately 10 μm is required. In addition, there are cases where a plurality of electrode patterns are formed on a substrate in an overlapping manner. In such cases, electrode patterns are overprinted while the plates are replaced. However, displacement of a printing position results in a spoiled electrode pattern. Therefore, for printing a precise electrode pattern such as one with an electrode width of approximately 10 μm as described above (although the print precision is slightly different according to the print target), it is sometimes required that the displacement of the printing position by the overlap be suppressed to several μm. Therefore, the printing of the electrode pattern on a substrate as described above requires print precision higher than that for the typical intaglio-plate offset printing which prints letters, characters, and images on paper or the like.

Conventionally, there have been proposed the following construction and method in order to increase the print precision of the offset printing. For example, as shown in FIG. 7, sliders 5 and 6 are secured, in the same size and the same arrangement, respectively to the lower sides of a plate carriage (plate table) 2, which supports a plate bed (not shown in the figure) for mounting a flat plate 1, and a print carriage (print target table) 4, which supports a printing bed (not shown in the figure) for mounting a glass substrate 3 as a print target (material to be printed). On the same rails (guide rails) 7, the plate carriage 2 and the print carriage 4 are moved (reciprocated) respectively via the sliders 5 and 6. In addition, a blanket cylinder (blanket roller) 8 is installed so as to cross the rails 7.

With such a construction, the straightness of the rails 7 is decreased directly beneath the blanket cylinder 8. As a result, even if the plate carriage 2 and the print carriage 4 are inclined in attitude at this position, both carriages 2 and 4 have the same inclination. Namely, attitudinal errors of a plate 1 and a glass substrate 3 are suppressed. This allows the transfer (resin transition) between the plate 1 and the blanket cylinder 8 to be performed at the same position as that of the re-transfer (picture transfer) from the blanket cylinder 8 to the glass substrate 3, it is possible to increase print precision.

When a plate 1 is mounted on the plate bed (not shown in the figure) supported by the plate carriage 2, markers, back plates, grooves, or other jigs are used as a benchmark. Furthermore, when a glass substrate 3 as a material to be printed is mounted on the printing bed (not shown in the figure) supported by the print carriage 4, jigs or the like are used as a benchmark (see Patent Document 3).

In addition, to increase print precision of the offset printing, another method as described below is available. An offset printer includes: a moving table on the upper surface of which an intaglio plate and a work piece as a print target are held; a blanket roller for transfer (rolling blanket) that is arranged above the moving table; two drive mechanisms one of which independently drives the moving table and the other independently drives the blanket roller; and two numerical value controllers one of which independently controls the drive mechanism for the moving table and the other independently controls the drive mechanism for the blanket roller. Furthermore, while movement of the moving table on which the intaglio plate and the work piece are held and rotation of the blanket roller are performed independently of each other, the operator finely adjusts the peripheral velocity of the blanket roller through manual input. This increases the precision of transfer (reception) from the intaglio plate to the blanket roller and of re-transfer (printing) from the blanket roller to the work piece (see Patent Document 4).

In typical offset printing, as schematically shown in FIG. 8, when transfer is performed between a blanket roller 9 and a flat-table-like plate 10 held on a plate table (not shown in the figure), and also when transfer or re-transfer is performed between the blanket roller 9 and a flat-table-like print target 11 held on a print target table (not shown in the figure), the blanket roller 9 is adapted to be pressed against the plate 10 or the print target 11 with a predetermined contact pressure (printing pressure). The blanket roller 9 has a surface of its peripheral wall made from a material with required elasticity such as required rubber. Therefore, at the time of the transfer or the re-transfer, the contact portion of the blanket roller 9 with the plate 10 or the print target 11, on which the predetermined contact pressure is applied, is deformed along the surface of the plate 10 or the print target 11.

To address this, the shape (planar shape) of a roller contact region 12 of the plate 10 or the print target 11 when the roller contact region 12 is contacted by the blanket roller 9 is an elongated rectangular region extending in the direction of the shaft center of the blanket roller 9 with a predetermined width (nip width) A in the direction orthogonal to the shaft center of the blanket roller 9 as shown by single-dot chain lines in FIG. 9.

### DOCUMENTS OF THE PRIOR ART

Patent Document 1: Japanese Patent No. 2797567

Patent Document 2: Japanese Patent No. 3904433

Patent Document 3: Japanese Unexamined Patent Application, First Publication No. 2008-129362

Patent Document 4: Japanese Unexamined Patent Application, First Publication No. 2000-272079

### PROBLEMS TO BE SOLVED BY THE INVENTION

However, for an electrode pattern such as for liquid crystal displays, there are cases where a fine electrode width of approximately 10 μm is required to be formed by printing, and also cases where the displacement of printing position by the overlap when the electrode patterns are overprinted is required to be suppressed to several μm, as described above. Therefore, in the method in which jigs or the like are used as a benchmark when a glass substrate 3 as a material to be printed is mounted onto the printing bed (not shown in the figure) supported by the print carriage 4 as shown in Patent Document 3, it is difficult to always obtain the repeatability of the attachment position of a glass substrate 3, which will be mounted newly onto the printing bed, with such accuracy as to suppress a positional error to the order of micrometers.

Furthermore, in the case of replacing the plate 1, even if, for example, markers, back plates, grooves, or other jigs are used for registration marks for a plate 1 to be mounted onto the plate bed (not shown in the figure) supported by the plate carriage 2, it is difficult to obtain the repeatability of the attachment position of a replacement plate to be mounted onto the plate bed with such accuracy as to suppress a positional error to the order of micrometers. In addition, the plate 1 may suffer from a displacement of printing position at the time of inking or transfer to the blanket cylinder 8.

Therefore, in the method shown in Patent Document 3, it is difficult to obtain highly precise repeatability of printing position at the time of offset printing.

Furthermore, in the method shown in Patent Document 3, even if there is a decrease in straightness of the rails 7 directly beneath the blanket cylinder 8, the transfer between the plate 1 and the blanket cylinder 8 is performed at the same position as that of the re-transfer from the blanket cylinder 8 to the glass substrate 3. However, the print precision may be decreased as a result of the print pattern lines being changed in thickness or the line being blurred.

Namely, as shown in FIG. 9, when offset printing is performed, the roller contact region 12 at which the plate 10 or the print target 11 is to be brought into contact with the blanket roller 9 has a predetermined width A in the direction orthogonal to the shaft center of the blanket roller 9.

On the other hand, as shown in FIG. 10A, in the case where, due to a decrease in straightness of the guide rails (not shown in the figure) for guiding a plate table (not shown in the figure) supporting the plate 10 and a print target table (not shown in the figure) supporting the print target 11, a table moving direction 13 (denoted with an arrow in the figure) of the plate table or the print target table directly beneath the blanket roller 9 is not precisely directed in the direction orthogonal to the shaft center of the blanket roller 9, for example in the case where the table moving direction 13 is inclined from the direction orthogonal to the shaft center of the blanket roller 9 by an inclination angle of B (in FIG. 10A, the inclination angle B is emphasized for the sake of convenience.), the following possibilities arise. The plate 10 and the print target 11 come to move along the table moving direction 13 beneath the blanket roller 9. Therefore, at the time of transfer of the print pattern from the plate 10 to the blanket roller 9 and the re-transfer of the print pattern from the blanket roller 9 to the substrate 11, a given site (point) of the plate or the print target 11 moving along the table moving direction 13 starts to contact the blanket roller 9 at a contact start position P0, moves through the roller contact region 12 with the width A along the table moving direction 13, and then leaves the blanket roller 9 at a contact end position P1, as shown in FIG. 10B. During this, a lateral displacement of the table moving direction 13 is caused in the direction of the shaft center of the blanket roller 9 by the dimension computed by multiplying A by tan B. Due to this lateral displacement, there is a possibility of the print pattern lines becoming thicker or blurred. In the case of printing a precise print pattern such as an electrode pattern with an electrode width of 10 μm, there is a possibility of insufficient print precision.

Furthermore, during the time when the plate 10 or the print target 11 is in contact with the blanket roller 9 while moving along the table moving direction 13 inclined from the direction orthogonal to the shaft center of the blanket roller 9, a force other than that in the vertical direction (the direction in which the blanket roller 9 is pressed) acts between the plate 10 or the print target 11 and the blanket roller 9. The action of this force may further decrease the repeatability of the precise print pattern.

The method shown in Patent Document 4 makes it possible to improve print precision by adjusting the peripheral velocity of the blanket roller through manual input. However, if the blanket roller is decentered, there is a change in peripheral velocity while the blanket roller rotates 360 degrees even if the rotational speed of the blanket roller is constant. Therefore, it is difficult to synchronize the peripheral velocity of the blanket roller and the moving speed of the intaglio plate held on the moving table or the work piece as a print target held on the moving table, resulting in difficulty in uniform transfer.

### DISCLOSURE OF INVENTION

Therefore, the present invention has an object to provide an offset printing method and an offset printing apparatus as follows. The present invention is capable of aligning a position of a plate held on a plate table with a position of a print target held on a print target table with high accuracy, thus increasing the repeatability of the printing position. Further more, even if the straightness of the guide rails for guiding the travel of the plate table and the print target table is decreased directly beneath the blanket roller, the present invention prevents a possibility of the print pattern lines becoming thicker or blurred, making it possible to obtain high repeatability. Furthermore, even if the blanket roller is decentered, the present invention is capable of easily synchronizing the peripheral velocity of the blanket roller and the moving speed of the plate or the print target in contact with the blanket roller. Thereby, it is possible to increase print precision. In particular, it is possible to print a fine pattern such as an electrode pattern with high precision. In addition, even in the case of overprinting, it is possible to suppress the displacement of the printing position by the overlap to the order of micrometers.

To solve the above problems, the present invention adopts the following. An offset printing method of the present invention brings a blanket roller from above into contact with a plate held on a plate table traveling on guide rails on a mount, and then brings the blanket roller from above into contact with a print target held on a print target table traveling on the guide rails, to thereby perform transfer of a print pattern from the plate to the blanket roller and re-transfer of the print pattern from the blanket roller to the print target. Furthermore, the offset printing method of the present invention includes the steps of: causing a plate to be held on an alignment stage provided on an upper portion of the plate table and also causing a print target to be held on an alignment stage provided on an upper portion of the print target table; and correcting a position of the plate by the alignment stage of the plate table and also correcting a position of the print target by the alignment stage of the print target table. Furthermore, in the step of correcting the positions of the plate and the print target, if table moving directions of the plate table and the print target table are not along a direction orthogonal to a shaft center of the blanket roller when the plate table and the print target table pass directly beneath the blanket roller, then the positions of the plate and the print target are corrected so that the plate table and the print target table pass directly beneath the blanket roller and also so that the plate and the print target are moved along the direction orthogonal to the shaft center of the blanket roller by the alignment stages of the plate table and the print target table As a result, after a print pattern is transferred from the plate to the blanket roller, positions of the print pattern are made identical at every re-transfer from the blanket roller to the print target.

In the offset printing method of the present invention, an initial alignment may be performed on every plate held on the alignment stage of the plate table and also on every print target held on the alignment stage of the print target table so that the plates and the print targets are respectively put in the same arrangement in a same alignment area provided at a predetermined site on the mount.

In the offset printing method of the present invention, if the blanket roller is decentered, a moving speed of the plate table on the alignment stage may be synchronized with a peripheral velocity in accordance with an apparent radius of the blanket roller from a center of rotation thereof to a peripheral position at a lowest end of a peripheral surface thereof when the plate table passes directly beneath the blanket roller. Furthermore, a moving speed of the print target on the alignment stage of the print target table may be synchronized with a peripheral velocity in accordance with an apparent radius of the blanket roller from a center of rotation thereof to a peripheral position at a lowest end of a peripheral surface thereof when the print target table passes directly beneath the blanket roller.

An offset printing apparatus of the present invention includes a plate table and a print target table that travel on guide rails provided on a mount, wherein a blanket roller is brought from above into contact sequentially with a plate held on the plate table and a print target held on the print target table, to thereby perform transfer of a print pattern from the plate to the blanket roller and re-transfer of the print pattern from the blanket roller to the print target. The offset printing apparatus further includes: an alignment stage provided on an upper portion of the plate table for supporting the plate from below; an alignment stage provided on an upper portion of the print target table for supporting the print target from below; and a controller for controlling the alignment stages of the tables.

In the offset printing apparatus of the present invention, an alignment area including alignment sensors may be provided at a predetermined site on the mount. Furthermore, the controller may include a function of giving a command to the alignment stage of the plate table so that an arrangement of the plate, which is detected by the alignment sensors, held on the alignment stage of the plate table arranged at a predetermined alignment position in the alignment area matches a predetermined arrangement. The controller may include a function of giving a command to the alignment stage of the print target table so that an arrangement of the print target, which is detected by the alignment sensors, held on the alignment stage of the print target table arranged at a predetermined alignment position in the alignment area matches a predetermined arrangement.

In the offset printing apparatus of the present invention, the controller may include data on displacement of a table moving direction from a direction orthogonal to a shaft center of the blanket roller resulting from a decrease in straightness of guide rails directly beneath the blanket roller. The controller may include a function of giving a command to the alignment stage of the plate table when the plate table passes directly beneath the blanket roller, to thereby correct a position of the plate so that the plate moves along the direction orthogonal to the shaft center of the blanket roller. The controller may include a function of giving a command to the alignment stage of the print target table when the print target table passes directly beneath the blanket roller, to thereby correct a position of the print target so that the print target moves along the direction orthogonal to the shaft center of the blanket roller.

In the offset printing apparatus of the present invention, the controller may include data on rotation angles of a decentered blanket roller and on a change in apparent radius of the blanket roller from a center of rotation thereof to a peripheral position at a lowest end of a peripheral surface thereof. The controller may include a function of providing, when the plate table passes directly beneath the blanket roller, the alignment stage of the plate table with a command to shift in a forward-rearward direction in a table traveling direction, to thereby synchronize a moving speed of the plate held on the alignment stage with a peripheral velocity of the decentered blanket roller at a lowest end of a peripheral surface thereof. The controller may include a function of providing, when the print target table passes directly beneath the blanket roller, the alignment stage of the print target table with a command to shift in the forward-rearward direction in the table moving direction, to thereby synchronize a moving speed of the print target held on the alignment stage with the peripheral velocity of the decentered blanket roller at the lowest end of the peripheral surface thereof.

### EFFECTS OF THE INVENTION

According to the present invention, excellent advantageous effects as follows are obtained.

(1) According to the present invention, firstly a blanket roller is brought from above into contact with a plate held on a plate table traveling on guide rails on a mount. Subsequently, the blanket roller is brought from above into contact with a print target held on a print target table traveling on the guide rails. As a result, in the offset printing method of performing transfer from the plate to the blanket roller and re-transfer from the blanket roller to the print target, with the plate being held on the alignment stage provided on an upper portion of the plate table and with the print target being held on the alignment stage provided on an upper portion of the print target table, a positional correction of the plate by the alignment stage of the plate table and a positional correction of the print target by the alignment stage of the print target table are performed. In the positional corrections of the plate and the print target, if a table moving direction when the plate table and the print target table moving along the guide rails pass directly beneath the blanket roller is not along a direction orthogonal to a shaft center of the blanket roller, the table moving direction is corrected. When the plate table passes directly beneath the blanket roller, the position of the plate is corrected by the alignment stage of the plate table, and the plate is moved along the direction orthogonal to the shaft center of the blanket roller. In addition, when the print target table passes directly beneath the blanket roller, the position of the print target is corrected by the alignment stage of the print target table, and the print target is moved along the direction orthogonal to the shaft center of the blanket roller.

As a result, even if the straightness of the guide rails for guiding the travel of the plate table and the print target table is decreased directly beneath the blanket roller, it is possible to prevent the possibility of every part of the plate or the print target slipping laterally with respect to the moving direction of the plate table and the print target table from the time when the part starts to contact the blanket roller till the time when the part leaves the blanket roller. Therefore, after a print pattern is transferred from the plate to the blanket roller, it is possible to prevent the lines of the print pattern re-transferred from the blanket roller to the print target from becoming thicker or faded. Thus, it is possible to increase the repeatability of the print pattern.

Thus, in the present invention, the positions of the print pattern re-transferred from the blanket roller to the print target after it is transferred from the plate to the blanket roller are the same every time.

In particular, it is possible to always make the position of the plate relative to the plate table the same without an influence of an error in the attachment position of the plate table to the alignment stage. Furthermore, it is possible to always make the arrangement of the print target relative to the print target table the same without an influence of an error in the attachment position of the print target to the alignment stage of the print target table.

As a result, it is possible to increase the repeatability of the printing position.

(2) According to the present invention, for every plate held on the alignment stage of the plate table and for every substrate held on the alignment stage of the print target table, an initial alignment is performed so that the plate and the substrate are in the same arrangement in the same alignment area provided at a predetermined site on the mount.

As a result, every time, it is possible to make the relative arrangement the same between the position of the plate when an alignment is performed in the alignment area and the position of the print target when an alignment is performed in the alignment area. Therefore, it is possible to print the print pattern of the plate onto the print target with highly precise positional repeatability.

(3) According to the present invention, if the blanket roller is decentered, the moving speed of the plate on the alignment stage of the plate table is synchronized, when the plate table passes directly beneath the blanket roller, with the peripheral velocity in accordance with an apparent radius of the blanket roller from its center of rotation to the peripheral point at the lowest end of its peripheral surface. Furthermore, also when the print target table passes directly beneath the blanket roller, the moving speed of the print target on the alignment stage of the print target table is synchronized with the peripheral velocity in accordance with the apparent radius of the blanket roller from its center of rotation to the peripheral point at the lowest end of its peripheral surface.

As a result, even if there is a change in peripheral velocity of the blanket roller while the blanket roller is rotated due to the decentering of the blanket roller, it is possible to move the plate or the substrate at a moving speed in synchronicity with that of the blanket roller. Thereby, it is possible to increase the repeatability of the print pattern.

(4) Thus, printing with high repeatability of a printing position and with high repeatability of a print pattern is performed on print targets, to thereby make it possible to print a precise print pattern such as an electrode pattern onto the print targets precisely and with high repeatability. Furthermore, even if a precise print pattern such as an electrode pattern is overprinted onto a print target, it is possible to suppress displacement in the overlap. Accordingly, it is possible to perform precise printing capable of suppressing displacement in the overlap to the order of micrometers.

### BRIEF DESCRIPTION OF THE DRAWINGS

FIG. 1 is a schematic perspective view showing a main part of a first embodiment of an offset printing method and an offset printing apparatus according to the present invention.

FIG. 2 is a schematic side view showing a whole construction of the offset printing apparatus of FIG. 1.

FIG. 3 is an enlarged view of FIG. 2 taken along the I-I arrow.

FIG. 4 is a schematic diagram showing a control configuration of a controller provided in the offset printing apparatus of FIG. 1.

FIG. 5 is a diagram schematically showing a controlling method of an alignment stage of each table in the offset printing apparatus of FIG. 1 in the case where a moving direction of each table directly beneath a blanket roller is inclined from a direction orthogonal to a shaft center of the blanket roller.

FIG. 6 is a diagram showing a schematic controlling method of the alignment stages of the tables in the case where a blanket roller is decentered in the offset printing apparatus of FIG. 1.

FIG. 7 is a plan view schematically showing a method for improving print precision of the offset printing as a method conventionally proposed.

FIG. 8 is a schematic side view showing a state of the offset printing in which the blanket roller is in contact with a flat-table-like plate held on a plate table or with a print target held on a print target table.

FIG. 9 is a schematic plan view showing a roller contact region of a plate or a print target to be in contact with the blanket roller.

FIG. 10A is a plan view schematically showing a moving direction of the plate table or the print target table in the case where the table is inclined from a direction orthogonal to the shaft center of the blanket roller as a result of a decrease in straightness of guide rails directly beneath the blanket roller.

FIG. 10B is an enlarged view of the roller contact region of the plate or the print target held on the plate table or the print target table in the case where the moving direction of the table is inclined from a direction orthogonal to the shaft center of the blanket roller as a result of a decrease in straightness of the guide rails directly beneath the blanket roller.

### BEST MODE FOR CARRYING OUT THE INVENTION

Hereunder is a description of an embodiment of the present invention with reference to the drawings.

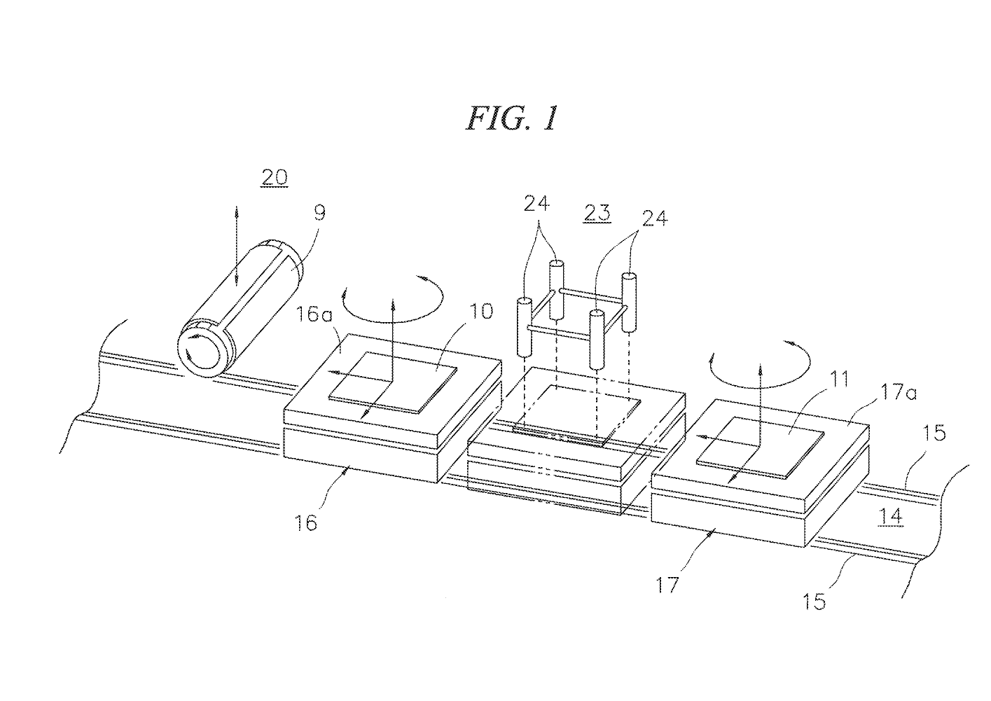

FIG. 1 to FIG. 6 show an embodiment of an offset printing method and an offset printing apparatus according to the present invention.

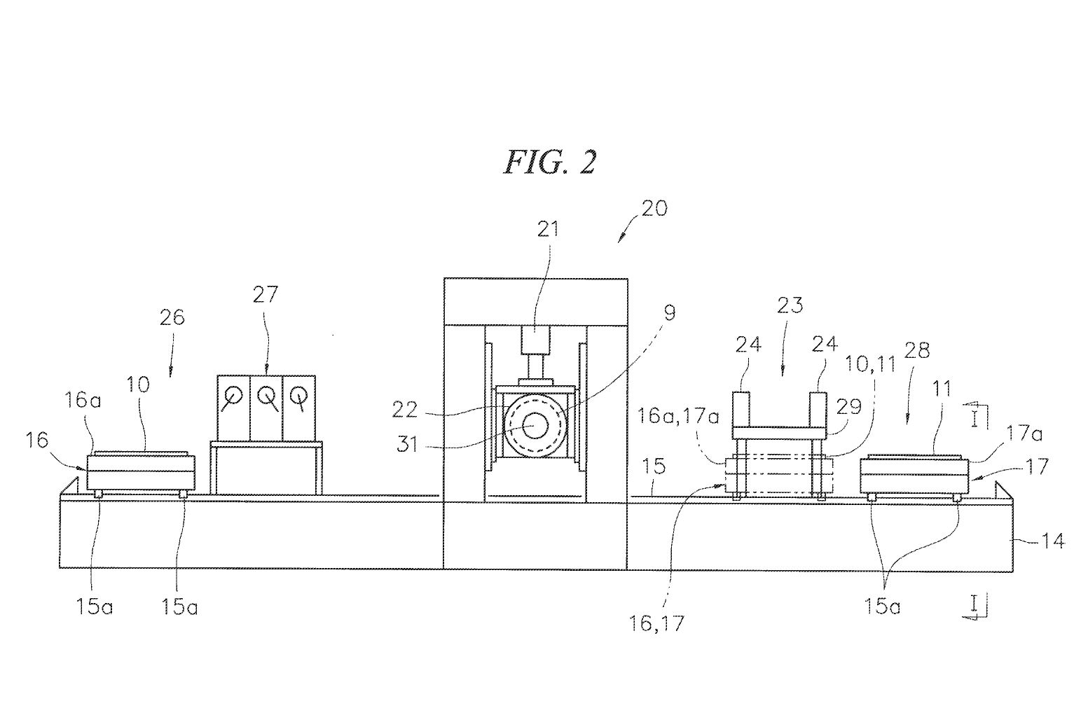

As shown in FIG. 1 to FIG. 3, guide rails 15 (for example, a set of two rails) extending in one direction (in the x axis direction) are provided on the upper side of a horizontal mount 14. On the guide rails 15, a plate table 16 and a substrate table 17 (print target table) are slidably attached each via a set of guide blocks 15a so as to be arranged in this order from a first end side of the guide rails 15 in the longitudinal direction (from the left side in FIG. 1 and FIG. 2).

The tables 16, 17 each include a drive device 18 such as a linear motor, and are capable of reciprocating (traveling) along the guide rails 15 independently of each other. In addition, with a common linear scale 19 provided along the guide rails 15 at a predetermined site on the mount 14, it is possible to detect positions of the plate table 16 and the substrate table 17 in the longitudinal direction of the guide rails 15, that is, absolute positions (coordinates) of the plate table 16 and the substrate table 17 relative to a predetermined point in the X axis direction.

On an upper portion of the plate table 16, there is provided an alignment stage 16a allowing for a horizontal movement in the longitudinal direction of the guide rails 15 (in the X axis direction) and in the direction orthogonal to the longitudinal direction of the guide rails 15 (in the Y axis direction), and also allowing for a rotation in the yaw angle (θ) with respect to the longitudinal direction of the guide rails 15. With this, it is possible to hold a plate 10 on an upper side of the alignment stage 16a.

In addition, similarly to the alignment stage 16a of the plate table 16, on an upper portion of the substrate table 17, there is provided an alignment stage 17a allowing for a horizontal movement in the X axis direction and the Y axis direction, and also a rotation in the yaw angle (θ). With this, it is possible to hold, for example, a substrate 11 (denoted with the same reference numeral as that for the print target 11, for the sake of convenience) as a print target 11 on an upper surface of the alignment stage 17a.

In a middle portion in the longitudinal direction of the guide rails 15 on the mount 14, there is provided a transfer mechanism portion 20 including: a blanket roller 9, which is arranged along the direction orthogonal to the longitudinal direction of the guide rails 15 (along the Y axis direction) so as to cross above the guide rails 15; a raising-lowering actuator 21 for raising/lowering the blanket roller 9; and a drive motor 22 for rotatingly driving the blanket roller 9.

Furthermore, at a predetermined site on the mount 14, for example at a site spaced a predetermined distance away from the transfer mechanism portion 20 to a second end side in the longitudinal direction of the guide rails 15, there is provided an alignment area 23 in which common alignment sensors 24 are used to align the plate 10 held on the alignment stage 16a of the plate table 16 and also to align the substrate 11 held on the alignment stage 17a of the substrate table 17.

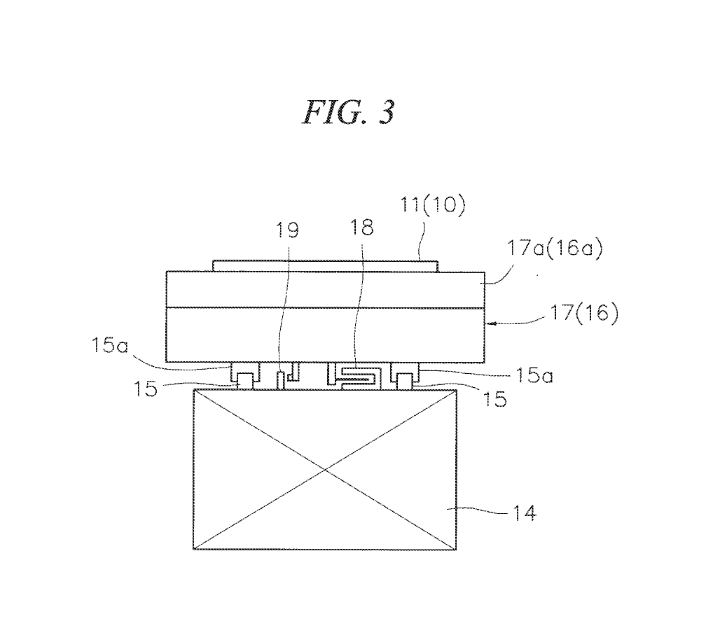

As shown in FIG. 3, the offset printing apparatus of the present invention further includes a controller (control device) 25 for giving commands to the alignment stages 16a, 17a respectively on the tables 16, 17 based on detection signals, which are input from the linear scale 19, for the positions of the plate table 16 and the substrate table 17 in the longitudinal direction of the guide rails 15 and also based on signals that are input from the alignment sensors 24.

The offset printing apparatus of the present invention is required to perform offset printing. Therefore, as shown in FIG. 2, there is provided a plate table waiting area 26 at a site corresponding to first ends in the longitudinal direction of the guide rails 15 on the mount 14. The plate table waiting area 26 is for keeping waiting the plate table 16, which has been moved to the first ends in the longitudinal direction of the guide rails 15. The offset printing apparatus of the present invention further includes an inking device 27 above the mount 14 between the plate table waiting area 26 and the transfer mechanism portion 20. The inking device 27 is for inking the plate 10 held on the alignment stage 16a of the plate table 16. The offset printing apparatus of the present invention further includes a substrate installation area 28 at a site on the mount 14 corresponding to second ends in the longitudinal direction of the guide rails 15. The substrate installation area 28 is for attaching a new substrate 11 to the alignment stage 17a of the substrate table 17 and removing a substrate 11 after printing while the substrate table 17 is kept waiting at the second ends in the longitudinal direction of the guide rails 15 after the substrate table 17 is moved to the second end.

In more detail, as shown in FIG. 1 and FIG. 2, a support mount 29 and precision cameras 24 (denoted with the same reference numeral as that for the alignment sensors 24) as alignment sensors 24 provided on the support mount 29 are provided above the alignment area 23 so as to face downwardly. The support mount 29 allows the plate table 16 and the substrate table 17 traveling along the guide rails 15 to pass therebeneath. The precision cameras 24 are provided so as to correspond to two opposing corners or four corners of the plate 10 held on the alignment stage 16a of the plate table 16, and also of the substrate 11 held on the alignment stage 17a of the substrate table 17. In FIG. 1, the precision cameras 24 are provided at four sites corresponding to the four corners of the plate 10 and the substrate 11.

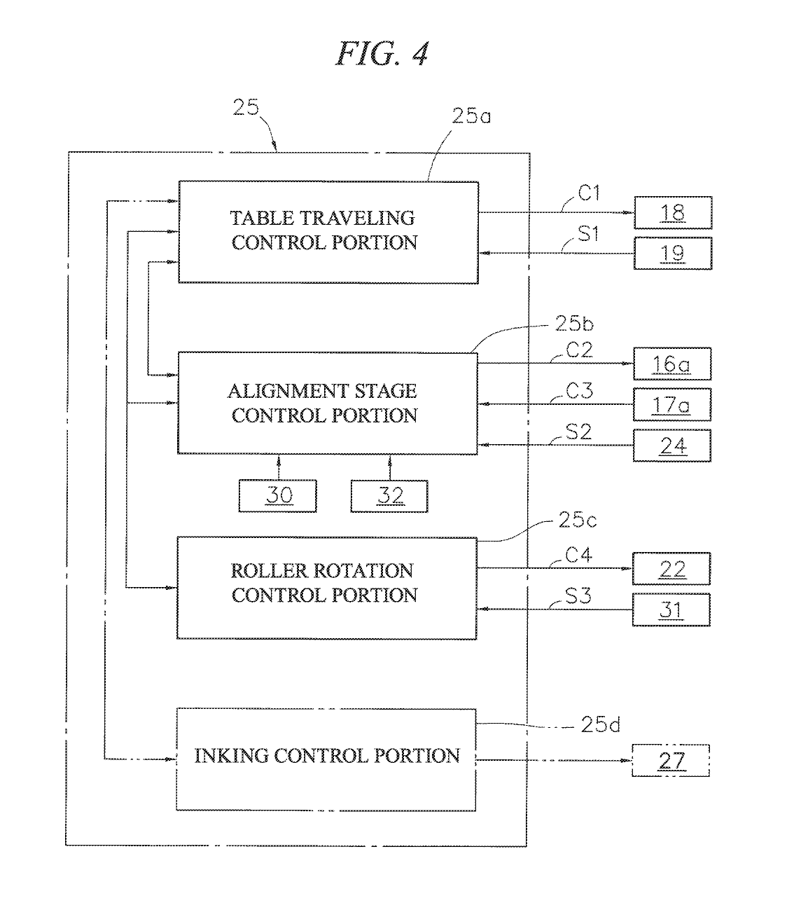

As shown in FIG. 4, based on table position detection signals S1, for each of the plate table 16 and the substrate table 17, which have been input from the linear scale 19 provided on the mount 14, the controller 25 gives a control command C1 corresponding table position detection signal to the respective drive devices 18 of the plate table 16 and the substrate table 17. As a result, it is possible to control the positions of the tables 16, 17 in the longitudinal direction of the guide rails 15 (in the X axis direction). The controller 25 further includes a table traveling control portion 25a capable of controlling a moving direction (traveling direction) and a moving speed (traveling velocity) of the tables 16, 17 by controlling the direction of the positional change (an increase/decrease in the X axis direction) and the amount of positional change per unit time when the positions of the tables 16, 17 are changed in the X axis direction.

The controller 25 further includes an alignment stage control portion 25b having a function of giving a correction command for correcting a sensor feedback to the plate table 16 and the substrate table 17 in the following manner. Firstly, in a state with the plate table 16 being arranged at a predetermined alignment position preset in the alignment area 23, the precision cameras 24 as the alignment sensors provided on the support mount 29 detect pointing markers (not shown in the figure) provided on the opposing corners or the four corners of the plate 10 held on the plate table 16. When signals S2 of the image are input from the precision cameras 24 to the alignment stage control portion 25b, the alignment stage control portion 25b gives a correction command C2 to the alignment stage 16a of the plate table 16. With the correction command C2, a sensor feedback alignment correction is performed so that the positions of the pointing markers detected by the precision cameras 24 match the preset positions. Similarly, in a state with the substrate table 17 being arranged at the predetermined alignment position, the precision cameras 24 detect pointing markers (not shown in the figure) provided on the opposing corners or the four corners of the substrate 11 held on the substrate table 17. When signals S2 of the image are input from the precision cameras 24 to the alignment stage control portion 25b, the alignment stage control portion 25b gives a correction command C3 to the alignment stage 17a of the substrate table 17. With the correction command C3, a sensor feedback alignment correction is performed so that the positions of the pointing markers detected by the precision cameras 24 match the preset positions. Note that the controller 25 is capable of associating the alignment stage control portion 25b with the table traveling control portion 25a to control the sensor feedback alignment correction.

Therefore, to align the plate 10 held on the alignment stage 16a of the plate table 16, the following operations are performed. Firstly, alignment markers (not shown in the figure) are pointed in advance on the opposing corners or the four corners of the plate 10. Next, in a state with the plate 10 being held on the alignment stage 16a of the plate table 16, a function of the table traveling control portion 25a of the controller 25 is used to move the plate table 16 to the alignment area 23 and stop the plate table 16 at the predetermined alignment position. After that, based on a function of the alignment stage control portion 25b of the controller 25, the positions of the alignment markers (not shown in the figure) on the opposing corners or the four corners of the plate 10 detected by the precision cameras 24 in the alignment area 23 are corrected to the preset positions through the horizontal movement in the X axis direction and the Y axis direction and through the rotation in the yaw angle (θ) of the alignment stage 16a of the plate table 16. This makes it possible to render the position of the plate 10 relative to the plate table 16 always the same without an error in the attachment position of the plate 10 with respect to the alignment stage 16a. In the case of replacing a plate for overprinting and also in the case of replacing a plate 10 worn (consumed) through use for a printing treatment with a new plate 10, an alignment of the plate 10 is performed every time it is replaced. Furthermore, a specified plate 10 may be aligned regularly for every predetermined number of printing times, or for every predetermined period of printing time.

When an initial alignment is performed on a substrate 11 held on the substrate table 17, the following operations are performed. Firstly, alignment markers (not shown in the figure) are pointed in advance on the opposing corners or the four corners of the substrate 11 to be used. Next, in a state with a substrate 11 to be used as a new print target being attached to and held on the alignment stage 17a of the substrate table 17 in the substrate installation area 28, a function of the table traveling control portion 25a of the controller 25 is used to move the substrate table 17 to the alignment area 23 and stop the substrate table 17 at the predetermined alignment position. After that, based on a function of the alignment stage control portion 25b of the controller 25, the positions of the alignment markers (not shown in the figure) on the opposing corners or the four corners of the substrate 11 detected by the precision cameras 24 in the alignment area 23 are corrected to the preset positions through the horizontal movement in the X axis direction and the Y axis direction and through the rotation in the yaw angle (θ) of the alignment stage 17a of the substrate table 17. This makes it possible to render the position of the substrate 11 relative to the substrate table 17 always the same without an error in the attachment position of the substrate 11 with respect to the alignment stage 17a. Therefore, it is possible to make the position of the substrate 11 when an initial alignment is performed thereon in the alignment area 23 relative to the position of the plate 10 when an initial alignment is performed thereon in the alignment area 23 always the same for every substrate 11. Consequently, after transfer of a print pattern to the blanket roller 9 by the plate 10, the print pattern can be re-transferred to the target position on the substrate 11 by the blanket roller 9 with high precision and also with high repeatability.

In the case where importance is attached to prevention of displacement of print patterns when overprinting is performed on a substrate 11 as a print target without requiring rigid repeatability of the first-layer print pattern for every substrate 11 as a print target, alignment markers may be pointed on the opposing corners or the four corners of the substrate 11 when a first printing is performed on the substrate 11 instead of pointing the alignment markers in advance on the opposing corners or the four corners of the substrate 11. In this case, an initial alignment need not be performed on the substrate 11 held on the substrate table 17 before the first printing is performed thereon.

The controller 25 further includes a database 30 in which is already stored data on the lowering in straightness of a portion of the transfer mechanism portion 20 arranged directly beneath the blanket roller 9 in the longitudinal direction of the guide rails 15, namely, data on inclination angles of the portion of the guide rails 15 from the direction orthogonal to the shaft center of the blanket roller 9. Furthermore, when the plate table 16 and the substrate table 17 travels directly beneath the blanket roller 9 of the transfer mechanism portion 20 by use of a function of the table traveling control portion 25a, the controller 25 uses the alignment stage control portion 25b to give a correction command to the alignment stages 16a, 17a respectively of the tables 16, 17 based on the data in the database 30.

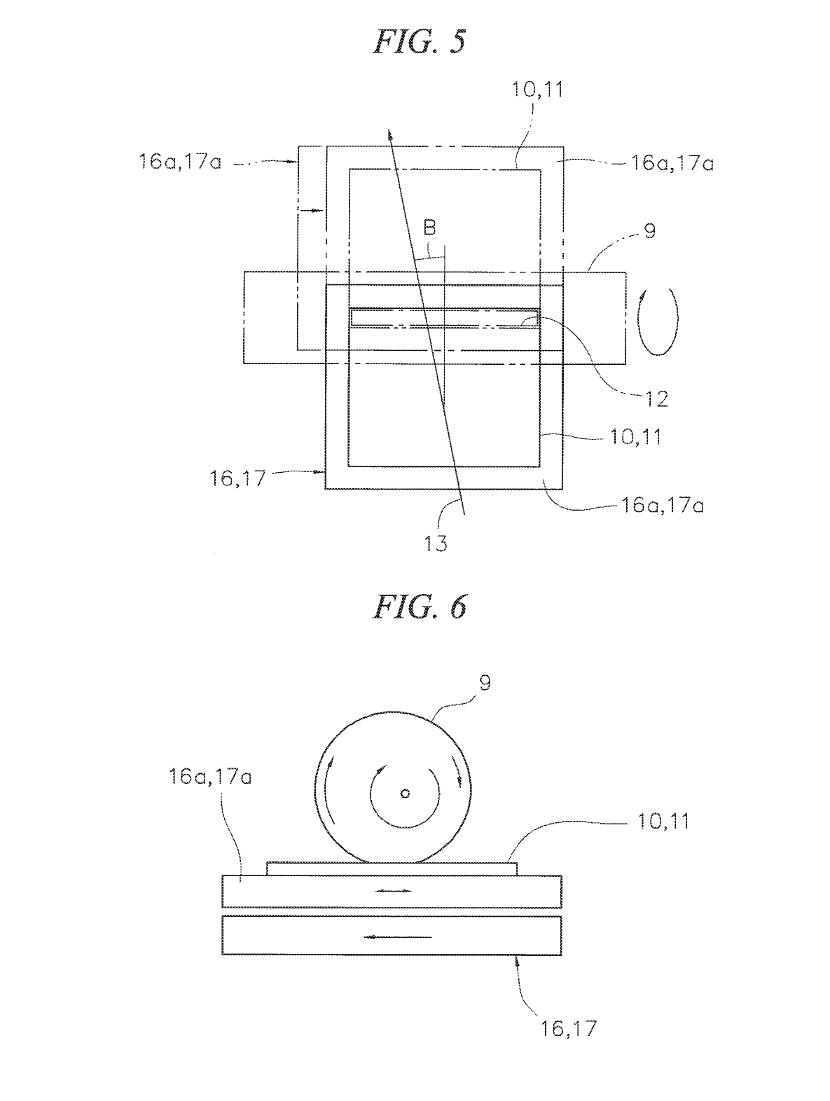

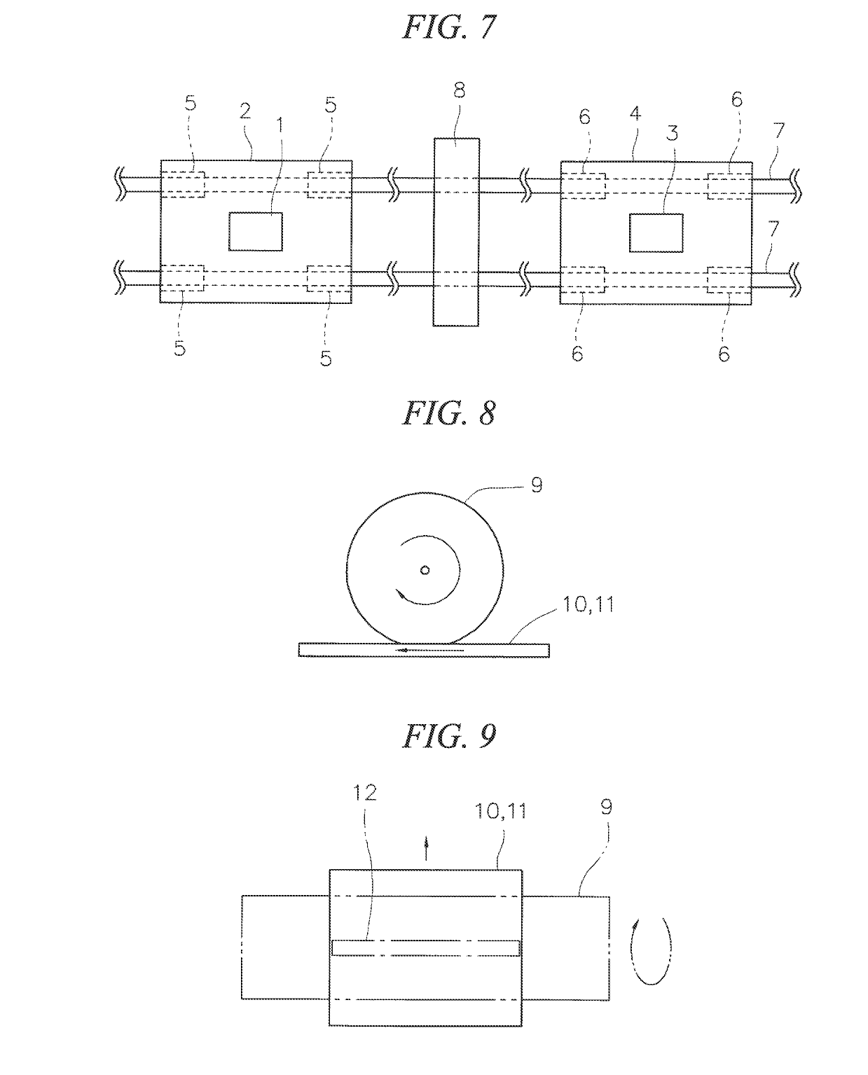

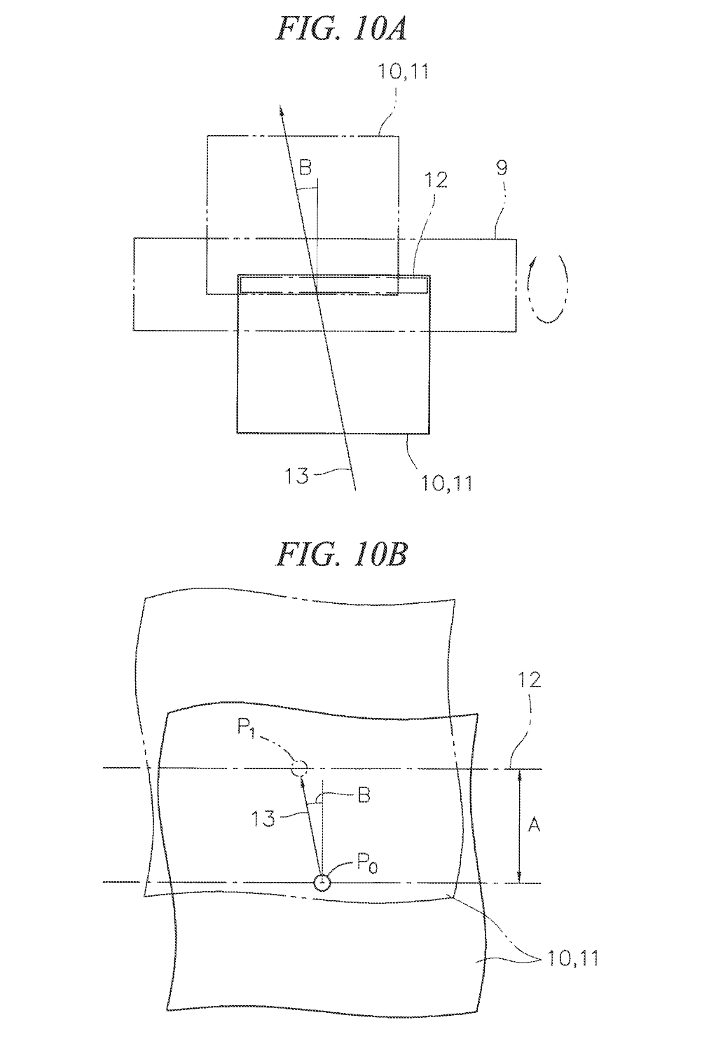

To be more specific, such a case is one as shown for example in FIG. 5, in which the guide rails 15 (see FIG. 1 and FIG. 2) are inclined, directly beneath the blanket roller 9, from the direction orthogonal to the shaft center of the blanket roller 9 by an inclination angle of B. In particular, in the case where table moving direction 13 (denoted with an arrow in the figure) of the plate table 16 or the substrate table 17 is inclined from the direction orthogonal to the shaft center of the blanket roller 9 by an inclination angle of B, the controller 25 associates the table traveling control portion 25a with the alignment stage control portion 25b. As a result, when transfer from the plate 10 to the blanket roller 9 and re-transfer from the blanket roller 9 to the substrate 11 are performed by causing the plate table 16 and the substrate table 17 to travel directly beneath the blanket roller 9, a correction command is given to the alignment stages 16a, 17a respectively of the tables 16, 17. Thereby, while the tables 16, 17 are advanced a unit distance in the X axis direction, the positions of the alignment stages 16a, 17a are sequentially corrected by tanB to the direction opposite to the direction in which the table moving direction 13 is inclined from the direction orthogonal to the shaft center of the blanket roller 9 (from the X axis direction). In FIG. 5, the inclination angle of B and displacement amounts of the alignment stages 16a, 17a of the tables 16, 17 are exaggerated for the sake of convenience of illustration. Otherwise, in FIG. 5, like constituent elements to those of FIG. 10A and FIG. 10B are designated with like reference symbols.

As for the data on the lowering in straightness of the guide rails 15 directly beneath the blanket roller 9, for example the plate table 16 or the substrate table 17 may travel at a low speed directly beneath the blanket roller 9 along the guide rails 15 in advance, and a displacement gauge or the like (not shown in the figure) may be used to measure a displacement of the table 16 or 17 in the direction to shaft center of the blanket roller 9.

As described above, even in the case where the table moving direction 13 is inclined from the direction orthogonal to the shaft center of the blanket roller 9, it is possible to correct the table moving direction 13 to the direction orthogonal to the shaft center of the blanket roller 9 during the time when all the sites (points) on the plate 10 and the substrate 11 held on the alignment stages 16a, 17a respectively on the tables 16, 17 pass the roller contact region 12 contacting with the blanket roller 9., which has a predetermined width A in the X axis direction. Therefore, after transfer of a print pattern from the plate 10 to the blanket roller 9, it is possible to prevent a possibility of the lines of the print pattern from becoming thicker or faded at the time of its re-transfer from the blanket roller 9 to the substrate 11.

If the guide rails 15 are curved directly beneath the blanket roller 9, when the tables 16, 17 travel along the curved guide rails 15, the inclination angle changes between the table moving direction 13 of the plate table 16 as well as the substrate table 17 and the direction orthogonal to the shaft center of the blanket roller 9. With this change, the angle (attitude) changes between the direction orthogonal to the shaft center of the blanket roller 9 and the plate 10 as well as the substrate 11 held respectively on the tables 16, 17. Therefore, in such a case, with the adjustment of the yaw angle (θ) of the alignment stages 16a, 17a of the tables 16, 17, the attitudes of the plate 10 and the substrate 11 held on the tables 16, 17 may be adjusted so as to be along the direction orthogonal to the shaft center of the blanket roller 9.

Incidentally, there are cases where the blanket roller 9 is decentered due to accuracy or the like with which it was manufactured. In this case, due to the decentering, the apparent radius of the blanket roller 9 from its center of rotation to its peripheral positions changes depending on the angle of rotation of the blanket roller 9. As a result, even if such a blanket roller 9 is rotated with a constant rotational speed, there is a possibility of change in its peripheral velocity.

In view of this, the controller 25 includes a sensor for detecting a rotational speed and an angle (attitude) in the circumferential direction of the blanket roller 9 of the transfer mechanism portion 20. For example, the sensor corresponds to a roller rotation control portion 25c that is capable of controlling the rotational speed and the rotational angle in the circumferential direction of the blanket roller 9 by giving a command C4 to the drive motor 22 based on detection signals S3 for the rotational speed and the rotational angle. The detection signals S3 are input from an encoder 31 fixed to the drive motor 22 of the blanket roller 9. Thus, with the association of the roller rotation control portion 25c with the table traveling control portion 25a and the alignment stage control portion 25b, it is possible to control the alignment stages of the tables.

The controller 25 further includes a database 32 in which is accumulated data obtained by previously measuring changes in apparent radius of the decentered blanket roller 9 from its center of rotation to the peripheral position at its lower end of the peripheral surface according to the change in rotational angle. With this, when a function of the table traveling control portion 25a is used to travel the plate table 16 and the substrate table 17 directly beneath the blanket roller 9 of the transfer mechanism portion 20, a correction command is given from the alignment stage control portion 25b to the alignment stages 16a, 17a respectively of the tables 16, 17 based on the data in the database 32.

To be more specific, the controller 25 associates the table traveling control portion 25a with the roller rotation control portion 25c. Thereby, when transfer from the plate 10 to the blanket roller 9 or re-transfer from the blanket roller 9 to the substrate 11 is performed while the plate table 16 or the substrate table 17 is caused to travel directly beneath the blanket roller 9 as shown in FIG. 6 at a speed in synchronicity with the peripheral velocity of the blanket roller 9 found from the rotational speed and the radius of the blanket roller 9, the controller 25 is capable of correcting the moving speed of the plate 10 or the substrate 11 held on the alignment stages 16a, 17a in the X axis direction by making the moving speed higher or lower than the traveling speed of the tables 16, 17. Firstly, based on the data in the database 32 on the decentering of the blanket roller 9, it is possible to find the peripheral velocity (an actual peripheral velocity of the contact portion with the plate 10 held on the plate table 16 or the substrate 11 held on the substrate table 17) by multiplying an apparent radius of the blanket roller 9 from its center of rotation to the peripheral position at the lower end of its outer peripheral surface by an angular velocity of rotation when the blanket roller 9 is at a specified rotational angle. Depending on the peripheral velocity, the alignment stage 16a or 17a respectively of the traveling table 16 or 17 is relatively displaced in the X axis direction with respect to the corresponding table 16 or 17 by use of a function of the alignment stage control portion 25b. As a result, it is possible to correct the moving speed of the plate 10 or the substrate 11 held on the alignment stage 16a in the X axis direction by making moving speed higher or lower than the traveling speed of the tables 16, 17. As a result, if the blanket roller 9 is decentered and an apparent radius of the blanket roller 9 from its center of rotation to the peripheral position at the lower end of its outer peripheral surface is large, then its peripheral velocity is high. Therefore, the alignment stage 16a or 17a of the traveling tables 16 or 17 is shifted to the forward side in the table traveling direction, to thereby increase the moving speed of the plate 10 or the substrate 11 held on the alignment stage 16a or 17a. On the other hand, if the apparent radius of the blanket roller 9 from its center of rotation to the peripheral position at the lower end of its outer peripheral surface is small, then the peripheral velocity is low. Therefore, the alignment stage 16a or 17a of the traveling table 16 or 17 is shifted to the rear side in the table traveling direction, to thereby decrease the moving speed of the plate 10 or the substrate 11 held on the alignment stage 16a or 17a. Thus, even if the peripheral velocity of the contact portion of the blanket roller 9 with the plate 10 or the substrate 11 is changed while the blanket roller 9 rotates 360 degrees, it is possible to synchronize the moving speed of the plate 10 or the substrate 11 with the peripheral velocity of the contact portion of the blanket roller 9. Therefore, when a print pattern, which has been transferred from the plate 10 to the blanket roller 9, is re-transferred from the blanket roller 9 to the substrate 11, it is possible to make the repeatability of the print pattern highly precise.

If the controller 25 includes an inking control portion 25d for controlling an operation of the inking device 27 as shown in FIG. 4 with a double-dotted line and the inking control portion 25d can be controlled in synchronicity with the table traveling control portion 25a, then the plate 10 held on the plate table 16 may be inked by the inking device 27 when the plate table 16 passes through the inking device 27.

When the offset printing apparatus of the present invention with the above construction is used to perform offset printing, firstly the alignment stage 16a of the plate table 16 is used in the alignment area 23 to align a plate 10 held on the plate table 16 every time the plate 10 is replaced after every passage of a predetermined period of printing time even if the same plate 10 is used again. In addition, every time a new substrate 11 is held on the substrate table 17, the alignment stage 17a of the substrate table 17 is used in the alignment area 23 to align the substrate 11. Thereby, every time, it is possible to repeat the position of the substrate 11 at the time it is aligned relative to the position of the plate 10 at the time it is aligned.

After that, the plate 10 is inked by the inking device 27. The plate table 16 moves the inked plate 10 to the transfer mechanism portion 20. While the plate table 16 is being traveled, the blanket roller 9 is brought from above into contact with the plate 10 held on the plate table 16 at a synchronized speed. Ink is transferred from the plate 10 to the blanket roller 9. Next, the substrate table 17 is traveled to move the substrate 11 held on the substrate table 17 to the transfer mechanism portion 20. Then, while the substrate table 17 is being traveled, the blanket roller 9 is brought from above into contact with the substrate 11 held on the substrate table 17 at a synchronized speed. Re-transfer to the substrate 11 is performed by the blanket roller 9. This operation is performed while substrates 11 as print targets are replaced, thereby the print pattern on the plate 10 is printed on the substrates 11.

Thus, according to the offset printing apparatus and the offset printing apparatus method of the present invention, an alignment is performed on the alignment stage 16a of the plate table 16, to thereby make it possible to hold the plate 10 at a predetermined position on the plate table 16 without an error of the attachment position of the plate 10 to the plate table 16 when the plate 10 is attached. Similarly, an initial alignment is performed on the alignment stage 17a of the substrate table 17, to thereby make it possible to hold the substrate 11 at a predetermined position on the substrate table 17 without an error of the attachment position of the substrate 11 to the substrate table 17 when the substrate 11 is attached. Therefore, it is possible to print a print pattern of the plate 10 onto a target position on the substrates 11 as print targets with high precision and with high repeatability.

Furthermore, even if the straightness of the guide rails 15 for guiding the travel of the plate table 16 or the substrate table 17 is decreased directly beneath the blanket roller 9, it is possible to prevent the possibility of an occurrence of a lateral displacement of the blanket roller 9 from the time when every part of the plate 10 or the substrate 11 starts to contact the blanket roller 9 till the time when the part leaves the blanket roller 9. Therefore, it is possible to prevent the lines of a print pattern, which have been transferred from the plate 10 to the blanket roller 9, from becoming thicker or blurred when the print pattern is re-transferred from the blanket roller 9 to the substrate 11. This can increase the repeatability of the print pattern.

Furthermore, even if due to the decentering of the blanket roller 9, there is a change in peripheral velocity of the blanket roller 9 when it is rotated, it is possible to move the plate 10 or the substrate 11 at a moving speed in synchronicity with the peripheral velocity of the blanket roller 9. This makes it possible to further increase the repeatability of the print pattern.

It is possible to perform a print onto the substrates 11 with high repeatability of printing position and also with high repeatability of print pattern. Therefore, it is possible to print a precise print pattern such as an electrode pattern onto the substrate 11 accurately and with high repeatability. Furthermore, even if a precise print pattern such as an electrode pattern is overprinted onto the substrate 11, it is possible to suppress the displacement due to the overlap to the order of micrometers, allowing for highly precise printing.

The present invention is not limited only to the above-mentioned embodiment. If the alignment stage 16a of the plate table 16 and the alignment stage 17a of the substrate table 17 are capable of aligning the corresponding plate 10 and the substrate 11 through the horizontal movement in the X axis and Y axis directions and the rotation in the yaw angle (θ), their size in the up-down direction and their planar shape may be appropriately modified. Alternatively, alignment stages provided with an optional operation mechanism may be used.

The alignment area 23 on the mount 14 may be arranged somewhere in the longitudinal direction of the guide rails 15 other than that shown in FIG. 2 so long as it does not interfere with the transfer mechanism portion 20, the inking device 27, the plate table waiting area 26, and the substrate installation area 28.

As for the alignment sensors 24 in the alignment area 23, optional alignment sensors other than the precision cameras 24 may be used so long as the position of the plate 10 held on the alignment stage 16a of the plate table 16 and the position of the substrate 11 held on the alignment stage 17a of the substrate table 17 arranged at a predetermined position in the alignment area 23 can be detected with high accuracy.

When the blanket roller 9 is brought into contact with the plate 10 held on the plate table 16 or the substrate 11 held on the substrate table 17 in the transfer mechanism portion 20, the correction by the alignment stages 16a, 17a of the tables 16, 17 for addressing the decrease in straightness of the guide rails as shown in FIG. 5, and the correction of the moving speed of the plate 10 or the substrate 11 for addressing the decentering of the blanket roller 9 as shown in FIG. 6 may be performed in a combined manner.

As for the raising-lowering actuator 21, an optional actuator may be used so long as the blanket roller 9 can be brought from above into contact with the plate 10 held on the plate table 16 or the substrate 11 held on the substrate table 17 traveling along the guide rails 15 in the transfer mechanism portion 20.

As for the inking device 27, an optional type of inking device 27 may be used so long as the plate 10 held on the plate table 16 can be properly inked.

The offset printing method and the offset printing apparatus of the present invention may be applied also to the case where a print target other than the substrate 11 is printed.

In the offset printing method and the offset printing apparatus of the invention, a variety of modification can be made without departing from the scope of the invention.

### DESCRIPTION OF THE REFERENCE SYMBOLS

9: blanket roller

10: plate

11: substrate (print target)

13: table moving direction

14: mount

15: guide rail

16: plate table

16a: alignment stage

17: substrate table (print target table)

17a: alignment stage

23: alignment area

24: precision camera (alignment sensor)

25: controller

30, 32: database

1. An offset printing method of bringing a blanket roller from above into contact with a plate held on a plate table traveling on guide rails on a mount, and then bringing the blanket roller from above into contact with a print target held on a print target table traveling on the guide rails, to thereby perform transfer of a print pattern from the plate to the blanket roller and re-transfer of the print pattern from the blanket roller to the print target, the offset printing method comprising the steps of:
causing a plate to be held on an alignment stage provided on an upper portion of the plate table and also causing a print target to be held on an alignment stage provided on an upper portion of the print target table; and
correcting a position of the plate by the alignment stage of the plate table and also correcting a position of the print target by the alignment stage of the print target table,
wherein, in the step of correcting the positions of the plate and the print target, if table moving directions of the plate table and the print target table are not along a direction orthogonal to a shaft center of the blanket roller when the plate table and the print target table pass directly beneath the blanket roller, then the positions of the plate and the print target are corrected so that the plate table and the print target table pass directly beneath the blanket roller and also so that the plate and the print target are moved along the direction orthogonal to the shaft center of the blanket roller by the alignment stages of the plate table and the print target table, and
wherein, after a print pattern is transferred from the plate to the blanket roller, positions of the print pattern are made identical at every re-transfer from the blanket roller to the print target.

2. The offset printing method according to claim 1,
wherein an initial alignment is performed on every plate held on the alignment stage of the plate table and also on every print target held on the alignment stage of the print target table so that the plates and the print targets are respectively put in a same arrangement in a same alignment area provided at a predetermined site on the mount.

3. The offset printing method according to claim 1,
wherein, if the blanket roller is decentered, a moving speed of the plate table on the alignment stage is synchronized with a peripheral velocity in accordance with an apparent radius of the blanket roller from a center of rotation thereof to a peripheral position at a lower end of a peripheral surface thereof when the plate table passes directly beneath the blanket roller, and furthermore a moving speed of the print target on the alignment stage of the print target table is synchronized with a peripheral velocity in accordance with an apparent radius of the blanket roller from a center of rotation thereof to a peripheral position at a lower end of a peripheral surface thereof when the print target table passes directly beneath the blanket roller.

4. An offset printing apparatus having a plate table and a print target table that travel on guide rails provided on a mount, in which a blanket roller is brought from above into contact sequentially with a plate held on the plate table and a print target held on the print target table, to perform transfer of a print pattern from the plate to the blanket roller and re-transfer of the print pattern from the blanket roller to the print target, the offset printing apparatus comprising:
an alignment stage provided on an upper portion of the plate table and configured to support the plate from below;
an alignment stage provided on an upper portion of the print target table configured to support the print target from below; and
a controller configured to control the alignment stages of the tables.

5. The offset printing apparatus according to claim 4,
wherein an alignment area comprising alignment sensors is provided at a predetermined site on the mount, and
wherein the controller comprises:
a function of giving a command to the alignment stage of the plate table so that an arrangement of the plate, which is detected by the alignment sensors, held on the alignment stage of the plate table arranged at a predetermined alignment position in the alignment area matches a predetermined arrangement; and
a function of giving a command to the alignment stage of the print target table so that an arrangement of the print target, which is detected by the alignment sensors, held on the alignment stage of the print target table arranged at a predetermined alignment position in the alignment area matches a predetermined arrangement.

6. The offset printing apparatus according to claim 4,
wherein the controller comprises:
data on displacement of a table moving direction from a direction orthogonal to a shaft center of the blanket roller resulting from a decrease in straightness of guide rails directly beneath the blanket roller;
a function of giving a command to the alignment stage of the plate table when the plate table passes directly beneath the blanket roller, to thereby correct a position of the plate so that the plate moves along the direction orthogonal to the shaft center of the blanket roller; and
a function of giving a command to the alignment stage of the print target table when the print target table passes directly beneath the blanket roller, to thereby correct a position of the print target so that the print target moves along the direction orthogonal to the shaft center of the blanket roller.

7. The offset printing apparatus according to claim 4,
wherein the controller comprises:
data on rotation angles of a decentered blanket roller and on a change in apparent radius of the blanket roller from a center of rotation thereof to a peripheral position at a lower end of a peripheral surface thereof;
a function of providing, when the plate table passes directly beneath the blanket roller, the alignment stage of the plate table with a command to shift in a forward-rearward direction in a table traveling direction to synchronize a moving speed of the plate held on the alignment stage with a peripheral velocity of the decentered blanket roller at a lowest end of a peripheral surface thereof; and
a function of providing, when the print target table passes directly beneath the blanket roller, the alignment stage of the print target table with a command to shift in the forward-rearward direction in the table moving direction to synchronize a moving speed of the print target held on the alignment stage with the peripheral velocity of the decentered blanket roller at the lowest end of the peripheral surface thereof
